(19) United States
(12) Patent Application Publication
(10) Pub. No.: US 2015/0149202 A1
(43) Pub. Date: May 28, 2015

(54) Medical Advice Via The Internet

(71) Applicant: Victor M. Hayes, Odessa, FL (US)

(72) Inventor: Victor M. Hayes, Odessa, FL (US)

(21) Appl. No.: 14/614,341

(22) Filed: Feb. 4, 2015

Related U.S. Application Data
(63) Continuation-in-part of application No. 13/650,689, filed on Oct. 12, 2012, now abandoned.

(51) Int. Cl. G06F 19/00; G06Q 50/22

(52) U.S. Cl. CPC G06F 19/3418; G06Q 50/22
USPC 705/2

(57) ABSTRACT

An Internet site provides medical advice to users. Accurate data collection and a summary of medical information is constructed by using a combination of Virtual Resources, pre-determined questions/questioning provided by physician moderators, and confirmatory patient data to provide a differential diagnosis based on a statistical likelihood of diagnosis as determined by the present system. Each online interaction will be patient specific (unique) as each patient has a unique set of issues surrounding their medical problem/condition for which the system provides the pre-determined questions. The system will calculate the statistical likelihood of diagnosis using a logic platform database. The logic of the program will improve over time because its interviewing skills will improve as it learns as lines of pre-determined questioning based on a visual pattern recognition tool as well as confirmatory data. The system will learn from its patients and that data will be reviewed and organized by physician moderators.

### RELATED APPLICATIONS

This patent application is a continuation-in-part of pending U.S. non-provisional patent application Ser. No. 13/650,689 filed Oct. 12, 2012, titled “Free Medical Advice Via The Internet” which claims the benefit of and/or priority under 35 U.S.C. §119(e) to U.S. Provisional Patent Application Ser. No. 61/546,356 filed Oct. 12, 2011, titled “Free Medical Advice Via the Internet” and U.S. Provisional Patent Application Ser. No. 61/595,255 filed Feb. 6, 2012, titled “Free Medical Advice Via the Internet” the entire contents of each of which is specifically incorporated herein by this reference.

### BACKGROUND OF THE INVENTION

1. Field of the Invention

The present invention relates to the field of medical advice and, more particularly, to providing medical advice via the Internet.

2. Background Information

Medical information regarding almost every human condition, ailment, affliction and/or disease (collectively, condition) can be located on the Internet. Internet sites having medical dictionaries, diagrams, condition specific information as well as sites dedicated to a particular condition, conditions and/or medical area(s) or specialty are available mostly for free. This allows an individual to locate information regarding an individual or personal condition as well as for another.

While these Internet sites can provide good medical information, the individual must inherently perform a self-diagnosis of the condition. Misdiagnosis, misinformation and/or insufficient information regarding the condition can pose a medical threat to the individual or other self-diagnosed individual. However due to the fact that such medical information is free, consulting Internet medical information is now becoming a first medical source for those seeking a medical diagnosis.

The alternative for the individual is to physically consult a medical professional. Due to current medical costs as well as socio and economic factors and/or considerations, people are now less likely to physically consult (i.e. in person) a medical professional about a particular condition.

Of course, it is generally preferable for an individual to physically see a medical professional in order to obtain patient specific medical advice about a particular condition and certainly in an emergency. However, due to various circumstances, factors and/or considerations, it is easier, faster for an individual to consult the Internet for medical information. Moreover, given that medical treatment is expensive and one may not have medical insurance, people more readily consult the Internet for medical information. Unfortunately, Internet sites only provide information about a particular condition or conditions and therefore cannot diagnose or provide accurate medical advice regarding an individual's particular condition. The individual must therefore self-diagnose. Self-diagnosis may lead to misdiagnosis which can have adverse consequences to the individual.

In view of the above, it would be desirable to provide accurate free medical advice to an individual via the Internet about an individual's specific condition.

The problems in the prior art addressed above, the desirables presented herein, and more are addressed by the present invention.

### SUMMARY OF THE INVENTION

A system and method provides medical advice, preferably, but not necessarily, for free to and for an individual via the Internet. This allows an individual to obtain medical advice regarding a probable diagnosis without the stress and wasteful cost of a physical medical consultation, diagnosis and advice.

The system and method is implemented within a medical advice Internet site (e.g. freemedicaladvice.com or freespineadvice.com) that is knowledgeable regarding a plurality of medical conditions through data collection, databases, statistical probability analysis, visual pattern recognition, differential diagnosis, baseline statistical likelihood of diagnosis, physician moderator(s), and confirmatory data). The medical advice Internet site may include a plurality of separate medical advice websites each one specific to a particular medical field or area such as, but not limited to, the spine (e.g. freespineadvice.com), orthopedics (e.g. freeorthoadvice.com), gynecology (e.g. freegynadvice.com), MVA (e.g. freemvaadvice.com), dermatology (e.g. freedermadvice.com) and urology (e.g. freeurologyadvice.com). Of course, other medical fields may be provided. As well, one Internet site may cover all disciplines.

The system and method may be implemented without a single general medical advice Internet site but rather with only the plurality of separate medical advice Internet sites each one specific to a particular medical field or area. The plurality of separate medical advice Internet sites are preferably, but not necessarily, linked, connected or otherwise associated with and to one another.

Each medical advice Internet site provides an online virtual interaction between a patient or user (i.e. an individual visiting the Internet site) and an intelligent computer program (system) capable of making complex medical decisions in the general and particular medial field or area with the input of physician moderators who establish a) questions used by the program, and b) baseline statistical likelihood of diagnoses, and use of confirmatory user data. The intelligent computer program (ICP) provides 1) accurate data collection and summary of medical information using a combination of virtual resources including VIPD, VP and VIPE (described below) and questions developed by the physician moderators, preferably, but not necessarily, with the aid of confirmatory/follow up user data, 2) a platform for logical interpretation of the medical data received as a result of the user interaction with the present virtual programming and user answers to the pre-determined questions, recognition of visual patterns within the data, and deducing the most statistical likelihood of diagnosis (SLD) based on information provided, 3) input from physician moderators that review confirmatory/follow up user data relative to user diagnoses, including adding and deleting pre-determined questions, and modification to pre-determined questions, providing advice on obtaining assistance for any condition, and to help an individual with condition problems to obtain the appropriate confirmatory/follow up data, work-up and imaging, medication recommendations/precautions, therapy, alternative treatments, physician referrals and surgical recommendations if necessary. The Internet site may allow ratings on providers along with the cost of treatment. Discount cards for referrals may be provided for additional cost savings. In this manner, the physician moderators will not have a direct say regarding a user's diagnosis, as the present program will present the differential diagnosis to the user. The physician moderators will use the confirmatory data to strengthen the ability of the programming during the diagnostic process.

Each online interaction will be individual specific (unique) as each individual has a unique set of issues surrounding their medical problem: e.g. sex, age, duration of symptoms and past medical history. However, the medical questions posed to the user in response to the various manners of obtaining user data as herein provided have been predetermined by the physician moderators. The programming uses the answers to the predetermined questions posed in response to user input/data collection and the visual pattern recognition logic of the programming to provide a differential diagnosis. Confirmatory communications (e.g. emails) with the users (patients) and/or direct implementation within a physicians medical practice, hospital, urgent care, or other medical facility to obtain objective evidence (from the user) that the system diagnosis has been confirmed.

The primary goal of the Internet site is to provide accurate, low cost or free medical advice to all individuals worldwide with a medical condition, consonant with the particular Internet site (if any), especially individuals with little or no means to otherwise obtain this help (e.g. uninsured/destitute/rural). Other goals of each Internet site are: 1) to obtain information about the individual's condition or disorder without the hassle, stress, time, and inconvenience of visiting a physician and/or other health care provider; 2) provide as much information about the particular condition(s) or disorder(s) as possible to the individual in “layman's” terms so they understand their problem, understand the diagnosis and recommended treatment options, understand the importance of such treatment and seek/implement the appropriate evaluation and management ASAP; 3) recognize patterns and calculate the statistical chance (% likelihood) of a diagnosis based on the lines of predetermined, physician moderator generated questions answered, store these patterns, and have the physician moderators and/or other medical professional(s) modify the database on a regular (e.g. monthly) basis to improve treatments; 4) use the statistical likelihood of a diagnosis to drive the decision making process when it comes to treatment (i.e. the logic of the program); 5) follow up with the individual or medical facility to gather confirmatory data on how well the program works with a particular medical diagnosis; 6) build the intelligent database over time as more physicians and medical professionals are involved in the program administrative functions (moderators), allowing the database to be used to standardize care and avoid unnecessary tests and procedures, as well as allow use by insurance carriers to justify ordering or not ordering tests (based on the statistical likelihood of a diagnosis); and 7) use information from the database to work with (and charge) health care insurance companies to drive down costs.

Large numbers of patients can be thus incorporated into the system/program for improved diagnostic ability of the website. When the program/website is used in conjunction with a physician's practice, medical facility, lab, rehabilitation facility, and/or otherwise, confirmatory data provided to the website allows the physician moderators and programming to modify itself for better resulting diagnostics.

The visual pattern recognition logic of the present system operates in conjunctions with physician moderators utilizing concept mapping and/or other visual means to review the extensive data that the program acquires. The data is used by the system to associate complex relationships between different groups of patients. This allows the physician moderators to improve the pre-determined questions/questioning, alignment of questions/questioning, change alignment of questions/questioning, and become more efficient in the diagnostic process.

The present system provides for accurate data collection from the user and a summary of medical information constructed using a combination of the present Virtual Resources including, but not limited to, VIPD, VP, VIPE, wherein the virtual body of the system is rotatable in three (3) axes for visualization mainly to allow the system/programming to withdraw medical information from the patient using visual keys, VDROs, and/or visual instructions. Each online interaction will be patient specific (unique) as each patient has a unique set of issues surrounding their medical problem/condition, e.g. different sex, age, duration of symptoms, type of symptoms and past medical history. A NSSH will be a constructed based on the information above. This will be a concise medical summary (about 1 paragraph) of the patients VIPD, VIH, & VIPE and results will be displayed to patients with hyperlinks on medical terms for additional information. Once this medical summary of the data is provided, the system will calculate the SLD using the Logic Platform Database.

The Internet site program's administrative functions allow a physician, physicians, or groups of physicians to oversee the Internet site and improve its diagnostic ability over time (physician moderator(s)). The logic of the program will improve over time because its interviewing skills will improve as it learns through concept mapping and visual pattern recognition logic as well as from physician moderator input such as the pre-determined questions, and the confirmatory data. These system will be able to recognize patterns visually (rather than from a spread sheet) and change the lines of questioning based on Concept Maps (and/or another visual organization tool). These Concept Maps help a physician understand cause and effect relationships. By using Concept Maps, a physician can recognize and organize the information in logical and meaningful ways. Each Concept Map serves its own purpose for a particular diagnosis and will be adapted or interconnected to similar diagnoses easily. The system will learn from its patients and that data will be reviewed and organized by groups of physicians. The system will also gain (medical) practice experience from the physicians involved in the website administration.

The website can be used in conjunction with electronic medical record programs and systems to improve efficiency of the programs and systems. Overall, the website/system utilizes computer programming with physician moderation to avoid mistakes, while providing a human component of the physical evaluation. This human component (physician moderator(s)) is on the back end of the present system not directly involved with patient care. Physician oversight, moderation coupled with the present visual data recognition techniques of the present system allow the moderator(s) to process a large amount of data noting similarities and making changes accordingly in order to improve the system/programming intelligence.

The Virtual Physical exam component of the present system may also receive and use medical data from remote computer-synchronized medical devices such as automatic blood pressure machines, EKG devices, heart rate monitors and the like to obtain additional patient information for the physical examination component of the present system.

### BRIEF DESCRIPTION OF THE DRAWINGS

The above mentioned and other features, advantages and object of this invention, and the manner of attaining them, will become apparent and the invention itself will be better understood by reference to the following description of the invention taken in conjunction with the accompanying drawings, wherein:

FIG. 1 is a representation of a system for providing medical advice to a user via the Internet per the principles of the present invention;

FIG. 2 is a diagrammatic representation of the present medical advice platform implemented on a computer of the present system, particularly for physician moderation, physician oversight, logical interpretation of user medical data input to the system, recognition of visual patterns within the inputted user medical data (visual data recognition), deducing the most statistical likelihood of diagnosis based on the inputted user medical data, and using confirmatory data to improve the diagnostic ability of the programming;

FIG. 3 is an illustration of an exemplary Internet site for implementing the present medical advice system, including an interactive virtual physician, a diagnosis section, and a rotating virtual body image that will show internal structures of the body once a pointing device hovers over a region of the body, and which also shows the internal structures that pertain to a diagnosis and which will help explain the diagnosis to the user in laymen's terms;

FIG. 4 is a diagram of an exemplary concept map as used by the present medical advice platform;

FIGS. 5A-C are diagrams of another exemplary concept map as used by the present medical advice platform;

FIG. 6A is a first part of a two-figure drawing of a diagrammatic representation of an exemplary patient profile and exemplary pre-determined questions/questioning along with user (patient) answers, which also shows a manner by which the present programming obtains patient data for the patient profile;

FIG. 6B is a second part of FIG. 6A;

FIG. 7 is a chart of the role and actions of the physician moderators of the present system;

FIG. 8 shows a Statistical Likelihood of Diagnosis (SLD) algorithm used by the present system/programming to provide a differential diagnosis Dx;

FIG. 9 shows is a further aspect of the Statistical Likelihood of Diagnosis (SLD) algorithm of FIG. 8;

FIG. 10 shows an algorithm for the visual pattern recognition logic of the present system using exemplary patient profiles; and

FIG. 11 shows an algorithm of the present system.

A description of the features, functions and/or configuration of the components depicted in the various figures will now be presented. It should be appreciated that not all of the features of the components of the figures are necessarily described. Some of these non-discussed features as well as discussed features are inherent from the figures. Other non-discussed features may be inherent in component geometry and/or configuration.

### DETAILED DESCRIPTION OF THE INVENTION

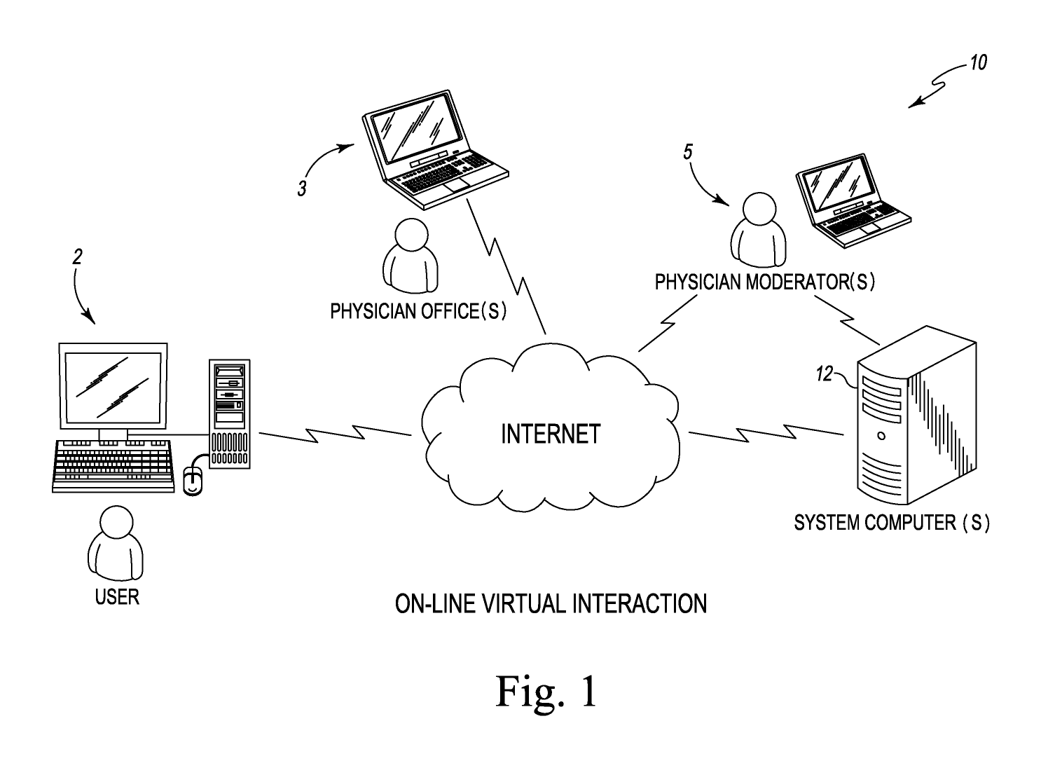

Referring to FIG. 1, there is shown an exemplary system, generally designated 10, for providing medical advice to a user via the Internet per the principles of the present invention. The system 10 uses the Internet to allow users to access a medical advice computer(s) or server(s) 12 in communication with the Internet and operating a medical advice platform per the principles of the present invention. A user/patient 2 is shown connecting to the medical advice computer(s)/server(s) [system computer(s)] 12. It should be understood that the depiction of one computer represents one or more computers, servers and the like necessary to carry out the present invention. For instance, one computer may host the medical advice Internet site, while another may host the medical advice logic or platforms. As such, the present invention will hereinafter be discussed with reference to the system computer 12. The medical advice system computer 12 implements the various programs, databases, logic, and other components as set forth herein.

FIG. 1 also shows a physician moderator 5 representing one or more such physician moderators 5 that connect to the system computer 12 (and thus the present system/programming) either via the Internet or directly with the system computer 12. Additionally, a physician office 3 is shown representing one or more physician offices, medical labs, medical facilities and/or the like that can connect to the system computer 12 for providing confirmatory/follow-up patient data. Of course, other connections to the system computer 12 by others via other means is anticipated.

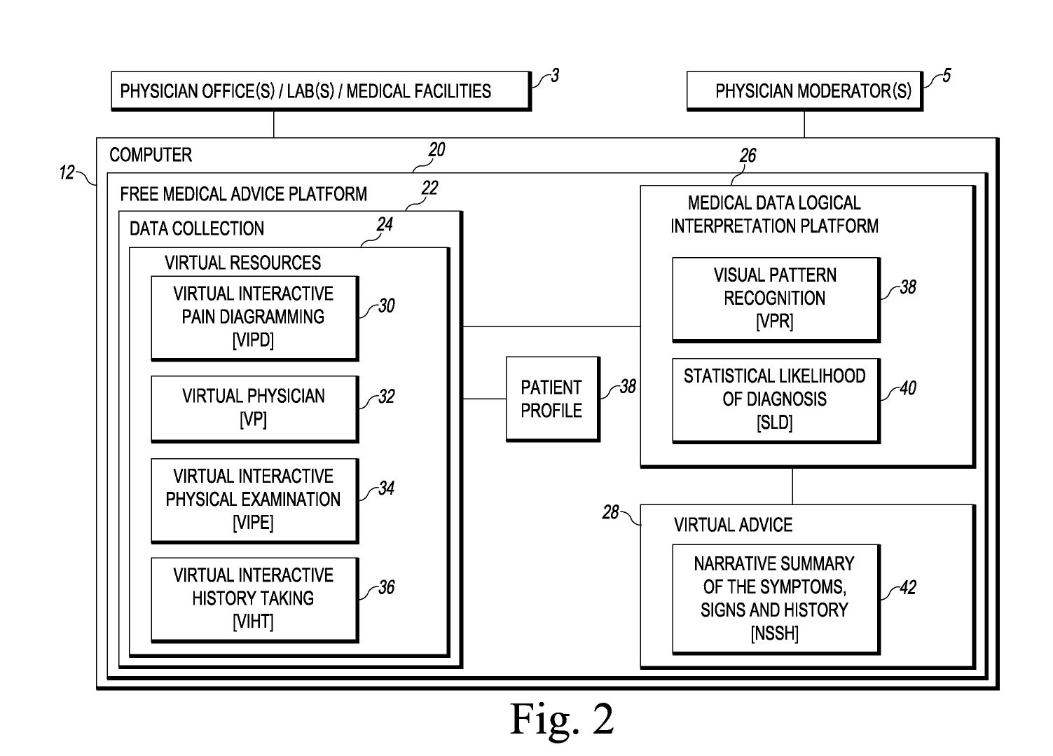

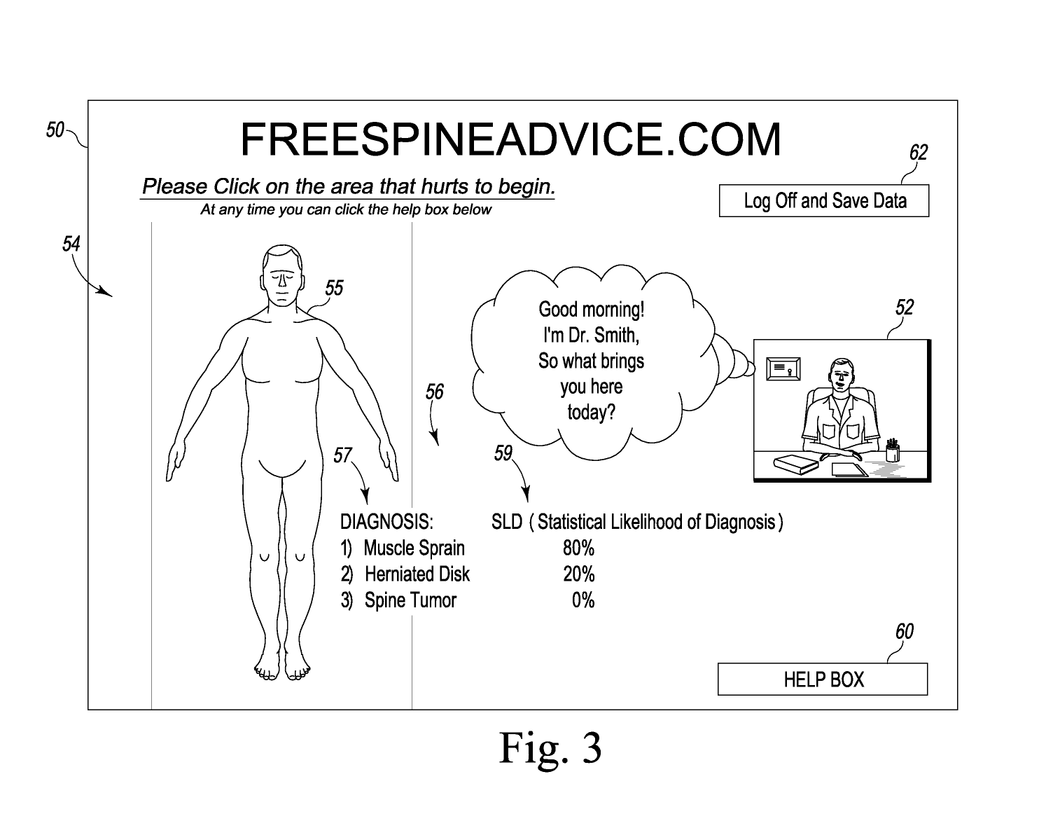

FIG. 2 depicts a diagram of the various programs, programming, data, logic, and/or platforms 20 used by the present medical advice system computer 12 and particularly as implemented through an Internet site such as the Internet site “FREESPINEADVICE.COM” (which is generally designated 50 as illustrated in FIG. 3). The Internet site 50 (or another website or websites the same or similar thereto) is the gateway to and the end implementation vehicle for providing medical advice, including a differential diagnostic, via the Internet in accordance with the present principles. It should be appreciated that the website may consist of several pages or screens if desired. Therefore, while only a single page or screen of the FREESPINEADVICE.COM Internet site 50 is shown, the FREESPINEADVICE.COM Internet site 50 may have more than one page or screen. An exemplary system and method for providing medical advice to and for an individual via the Internet via an all-encompassing general medical knowledge Internet site will now be provided with respect to the medical condition being a spine disorder. It should be understood that the following is applicable to all of the present free medical advice Internet sites as described herein.

The medical advice platform 20 includes data collection 22 to collect or obtain data from a user using the spine advice Internet site/system/programming 50. The Internet site 50 preferably, but not necessarily, requires a user to log onto the site. Data collection 22 includes various virtual resources 24 for presenting information to the user and collecting medical data from the user in order to provide medical advice and/or statistically determined diagnoses to the user. The virtual resources 24 includes a virtual interactive pain diagramming (VIPD) 30 that is configured to generate a virtual interactive pain diagram 54 (see FIG. 3) of a body 55, optionally a virtual physician (VP) 32 that is configured to generate a virtual physician 52 (see FIG. 3) that communicates with the user via text (such as shown in FIG. 3 where a user is being welcomed to the Internet site). Data collection 22 also includes virtual interactive physical examination (VIPE) 34 and virtual interactive history taking (VIHT) 36 both of which are configured to allow a user to interact with the VP 52 and the VIPD 54 by text inputted by the user and through the user pointing and clicking on the interactive body 55 of the VIPD 54 typically, but not necessarily, as asked, directed or guided by the VP 52. The VP 52 asks various pre-determined, physician moderator generated questions/questioning of the user/patient based on the data provided by the user via inputted answers to the pre-determined questions/questioning which changes according to the patient's answers, a patient profile 8, and the VIPD 54. The virtual body 55 may rotate in 3 axes to allow the user to employ a pointing device (e.g. a mouse) to select or point out an area, areas or particular body system, organ, bone, joint or the like as asked by the VP 52 or independently provided by the user as part of the data collection. The physician moderator(s) 5 are shown as a component of the present medical diagnostic system. While optional, physician office(s), lab(s), medical facilities, and/or other patient/user medical data gathering facility 3 is also shown as a component of the present medical diagnostic system. A patient or user is not shown in FIG. 2.

The medical advice platform 20 also includes a medical data logical interpretation platform 26 that is configured to analyze the collected medical data from answers generated by the system. The medical data logical interpretation platform 26 includes visual pattern recognition (VPR) 38 that is configured to recognize patterns in the collected medical data, particularly with respect to all of the medical data collected by the site, in order to determine a diagnosis for the particular user per the medical information or data obtained from the user during their on-line session, and statistical likelihood of diagnosis (SLD) 40 configured to determine statistical likelihood of particular medical diagnoses based on the collected user medical data per directed questions or a line of the pre-determined questions/questioning by the VP 52, VPR 38 and other logical programming of the medical advice platform/programming 22. The SLD 40 drives the decision making process from the logic (VP 52) of the medical advice platform 20. The medical data logical interpretation platform 26 further includes virtual advice 28 that includes a narrative summary of the symptoms, signs and history (NSSH) of the user as determined by the logic of the medical advice system 20.

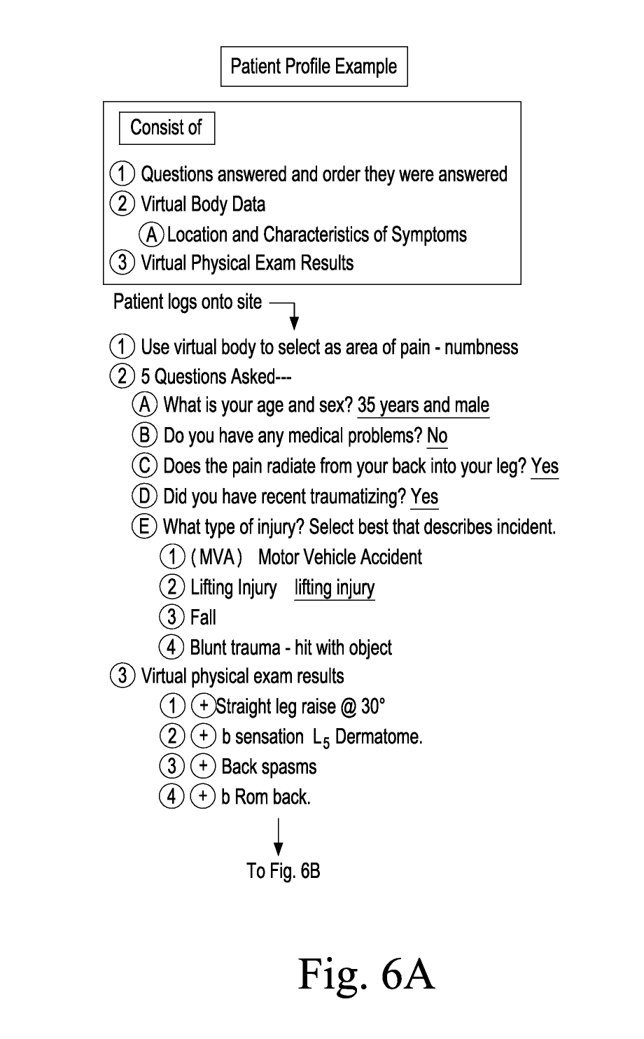

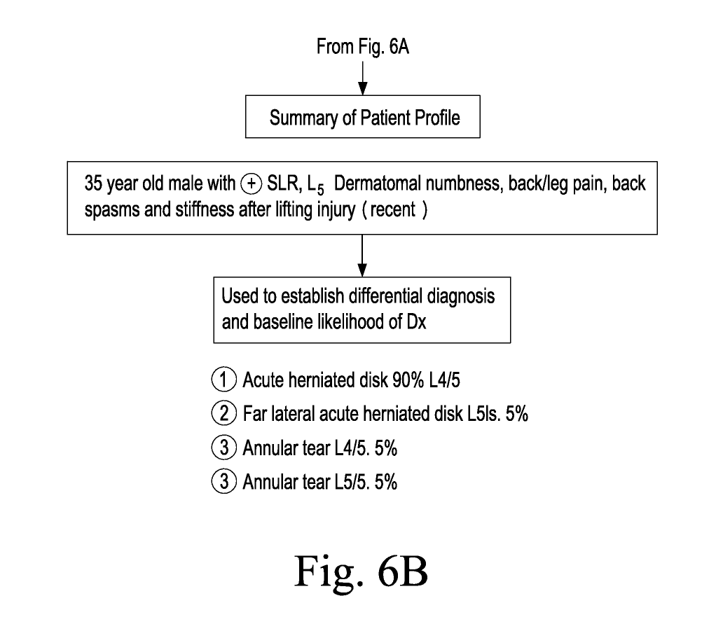

The spine advice Internet site 50 further provides help for the site that the user may access by clicking on the Help Box 60. Selecting the Help box 60 takes the user to another page or screen (not shown) that provides help to the user in the form of dialog between the user and the VP 52, frequently asked question and the like. Since the spine Internet site 50 preferably, but not necessarily, uses a log-in system to access and use the site, the page 50 includes a Log Off and Save Data box 62 that logs off the user then saves the data associated with the particular user (a patient profile—see, e.g. FIGS. 6A, 6B). Once the appropriate medical data and answers to the calculated series of the pre-determined medical questions asked by the VP 52 as provided by one or more physician moderators, the system provides one or more diagnoses listed in order of their statistical likelihood of diagnosis (SLD) (i.e. a differential diagnosis). Particularly, the site 50 has a differential diagnosis section 56 where one or more diagnoses 57 are listed as predicted by the system logic as well as a percentage that the particular diagnosis is the likely medical condition (i.e. the Statistical Likelihood of Diagnosis—SLD 59).

One provision of the present system and method for providing medical advice to and for an individual/patient via the Internet is the accurate collection of data, both from the site user/patient and from user/patient confirmatory sources. The Internet site or website may have a splash or opening page consisting of the Virtual Interactive Pain Diagramming (VIPD) system along with pre-determined questions. The VIPD will have a pointer to specify the area of pain and discomfort and this will aid in presentation of the pre-determined questions/questioning on symptoms and other patient data (i.e. personal statistics, habits, existing conditions, medical history, medical procedures, diet, exercise, etc.) being experienced by a patient/client. The VIPD will be able to obtain the information about the (subjective) symptoms experienced by using a combination of both visual cues on a human model and answers to pre-determined questions/questioning thereto and the predetermined questions/questioning that may be asked by the virtual physician (VP) 52 located on the website. This data will be stored in the database within the patient profile, an example of which is illustrated in FIGS. 6A, 6B and used to drive the patient history taking

The system, with or without the use of the VP 52 will perform a standard patient history for the patient profile just as a normal spine surgeon/physician would perform in his or her office, asking pre-determined specific questions based on user answers to the pre-determined questions/questioning focused on obtaining the most likely diagnosis, directing the history and the patient/virtual doctor interaction. This may be termed Virtual Interactive History (VIH) which may be a part of the patient profile. Age, sex, weight, height, duration and intensity/location of symptoms/signs, accurate medical history, current medications will all be some of the questions asked by the VIH. The VIH will key in on the patient signs (objective) frequently caused by a specific spine illness if this is suspected based on answers given to prior lines of questioning. The VIH program will NOT use a symptoms checker like WebMD does where a patient clicks on their symptoms. The Virtual interactive history taking program will be the driving force for steering the patient towards a particular diagnosis as efficiently as possible.

The VIPD and VIH may initiate the Virtual Interactive Physical Examination (VIPE) process. The VIPE process may consist of a series of simple physical exam maneuvers that will be performed by the patient within the confines of their home (to obtain the maximum amount of information about the patient's physical condition at the present time). These physical examination maneuvers will use videos, diagrams and visual cues to have these tests performed correctly. The patient will enter the results in a drop down menu.

Examples of the VIPE process are:

A diagram illustrating a straight leg raise test being performed by a doctor. Upon further questioning if the patient doesn't understand this, a video of a doctor examining a patient and performing a straight leg raise test will be shown. The diagram and the virtual doctor will explain positive findings and what to document with regards to results;

The patient is instructed to place their feet together, keep their knees straight and try to touch their toes. You should stop as soon as they start having any discomfort. How far can you bend over?

The VIPE may provide questions that may be answered by typing in a text box or selecting an appropriate response from a drop down menu. For instance, with regard to medical advice about a spine condition, the VIPE may ask the user to “Select the following Answer from the drop down menu: “How far can you bend over?” The user may select, for example, “Unable”.

These answers may elicit additional questions. The Virtual Physician/Doctor via the pre-determined questions/questioning may respond: “You can barely bend over, your condition seems severe, and we may need to refer you to a specialist immediately for a further evaluation. Take this Summary of your findings to one of the physicians of your choice listed below”

The Internet site 50 can provide a Narrative (Summary) of the Symptoms, Signs, and History (NSSH) which can be incorporated into or be the patient profile. The NSSH will be a concise medical summary (about 1 paragraph) of the patient's VIPD, VIH, & VIPE results will be displayed to patients with hyperlinks on medical terms for additional information. An arrow over a hyperlink will describe the word or series of words the term in layman's terms or with pictures/videos.

Example of an NSSH:

This patient is a 42-year-old male construction worker and heavy laborer. The patient has a long-standing history (>15 years) of 75% back pain (located over his lower lumbar region @ L4-L5) and 20% right>left lumbar sciatica symptoms (with numbness and pain but no weakness in his legs). His symptoms have dramatically worsened after he lifted a heavy box at work two weeks ago. The sciatica pain is radiating into his buttocks and travels down the back of the leg towards his feet with associated numbness (In the L5 Dermatome). Treatment wise, he has taken over the counter Anti-inflammatory medication (which mildly helped) but has not had formal physical therapy, Chiropractic therapy, alternative treatments, bracing, or other conservative care. The patient denies problems with balance, fine motor coordination, or spine related bowel or bladder symptomatology.

The patient will confirm the accuracy of the NSSH and edit areas of inaccuracy before signing off on the narrative summary. Once the Narrative Summary (NSSH) is accurate, the logic of the program will analyze all the information obtained and deduce the most common diagnosis and/or diagnoses (up to a set amount, e.g. 3).

The Internet site 50 thus includes the logical platform 20 for interpretation of medical data, the logical platform 50 consisting of a large database of the pre-determined questions/questioning provided by the physician moderators. The types and sequence of the pre-determined questions/questioning asked will be pulled from the Logic Database and will depend on the responses from the patient. A database will be initiated and moderated by board certified (US) physicians and/or specialists in the particular medical field/area based on the medical experience and expertise in treating the medical disorders (physician moderators). Other physicians and/or medical professionals may be allowed to provide input and/or administrate the program adding knowledge/experience to the virtual doctor logic. The databases SLD (Statistical Likelihood of Diagnosis) function will become more efficient and accurate as the program recognizes and learns patterns of answers. These patterns will determine how the lines of questioning are organized and rearranged.

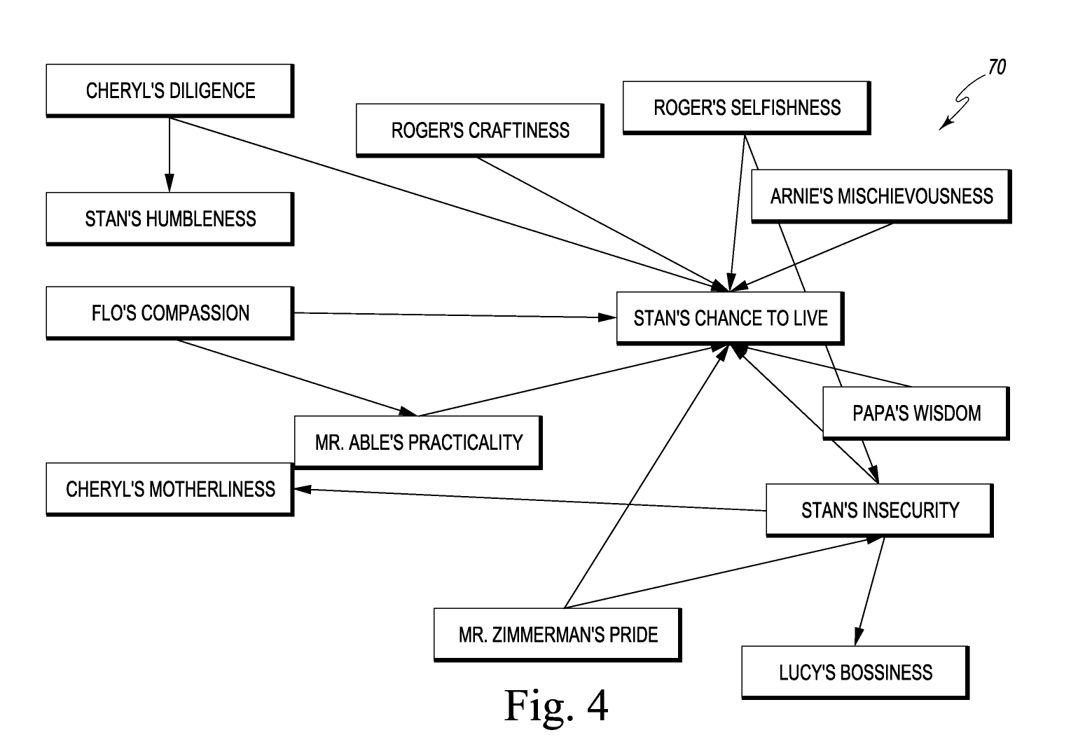

The program's administrative functions will allow groups of physician moderators to oversee the site and improve its diagnostic ability over time. The logic of the program will improve over time because its interviewing skills will improve as it learns which (groups) of questions arrive at a particular diagnosis faster than others. These moderators will be able to recognize patterns visually (rather than from a spread sheet) and change the lines of questioning based on concept maps (and/or another visual organization tool). These concept maps help a physician understand cause and effect relationships. By using concept maps, a physician can recognize and organize the information in logical and meaningful ways. Each concept map serves its own purpose for a particular diagnosis and can be adapted or interconnected to similar diagnoses easily (By dragging and interconnecting arrows). A sample concept map 70 is provided in FIG. 4 based on a fictitious novel.

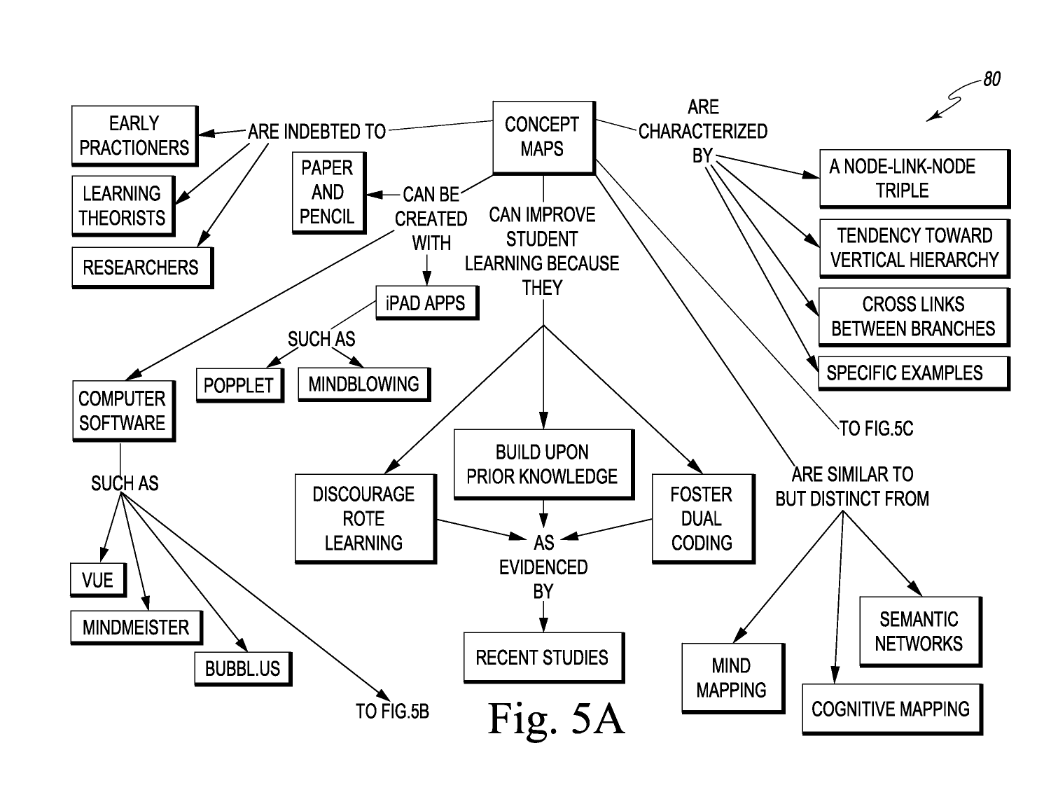

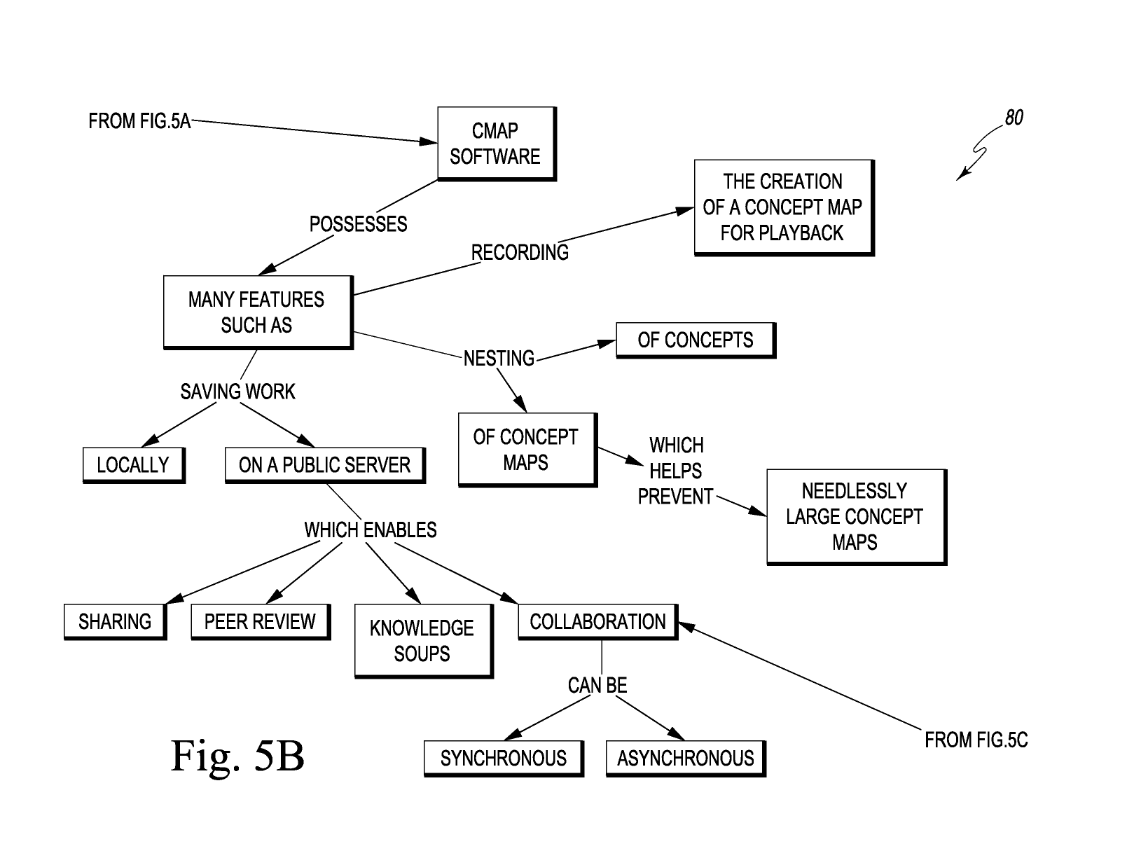

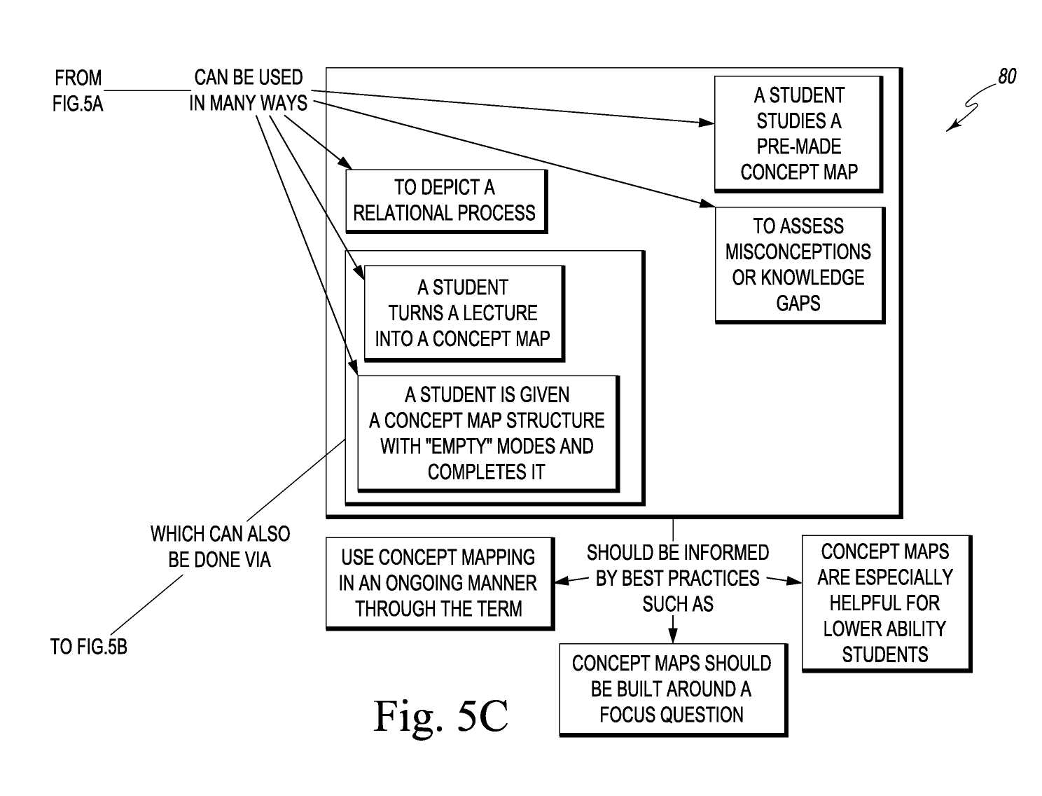

FIGS. 5A, 5B, 5C depict another sample concept map 80. By using clustering and concept mapping the data collected as people use the site, physicians can visually organize and interconnect relationships between similar diagnoses in logical and meaningful ways. Each map serves its own purpose and can be adapted in a variety of ways. This will be the brains of the virtual medical (e.g. spine) specialist. It will not forget to ask an important question because it is not paying attention to you.

The virtual diagnosis procedure or steps can be summed up as follows:

VIPD-->Virtual Doctor Appears-->VIH-->VIPE-->Narrative summary of Symptoms/Signs/History.----->SLD Logic: The database grows, patterns are recognized and the VIRTUAL SPINE SPECIALIST learns. The physician moderator(s) add, change, delete and/or otherwise modify the pre-determined questions based on the learning of the system.

The Internet site 50 will be HIPPA compliant and will not release any (patient specific) medical information about the patient to outside sources. The Internet site will provide a printed copy of the information and data collected to the patient to give to the health care provider. The Internet site is by no means a substitute for a doctor's office visit. This Internet site will be an option for some individuals to reduce health care cost due to the extremely high health care expenses and unnecessary testing/treatments ordered.

Revenue generation may be accomplished by administrative fees. The medical advice/information/diagnosis will not cost the individual/patient at all. The revenue from the Internet site may come from an administrative fee charged to the providers that want to receive referrals from the Internet site. The provider may sign a contract with the Internet site. These health care providers will include but are not limited to all types of clinicians/physicians (e.g. PT, chiropractors, medical doctors/nurse practitioners, imaging centers, pharmacies, ECT). They will be graded by the patients they evaluate and treat. This will be disclosed to the patients so they have the choice of selecting a provider and/or pharmacy. Links will be provided to outside provider websites and/or locations based on the patients location to expedite treatment.

The Internet site may also negotiate down charges between similar merchants to drive down cost. The Internet site will provide discount cards for over the counter medications, imaging tests, and physician visits. For example, you likely have arthritis type back pain and the standard treatment is anti-inflammatory medication. You can buy this anti-inflammatory over the counter at pharmacy A or pharmacy B. Our pharmacy B price is 75 cents cheaper. Print and take this discount card with you to receive the best price. As another example, you likely have a herniated disk in your spine and the weakness in you right leg from this problem. Since you symptoms have not responded to therapy and medications for 10 weeks the standard recommendation by the AMA is to obtain an MRI as soon as possible. In your resident State only a chiropractor or medical physician (MD or DO) can legally order an MRI. Since the average emergency visit for treating back pain is $8000 in your region, we recommend you visit an MD or a chiropractor for further evaluation. A “Click Here” link for Recommendations on Evaluation and Management may then be provided. These medical facilities, along with hospitals, labs, physician offices and otherwise, also preferably provide confirmatory data to the present system for use in honing the pre-determined questions/questioning and the SLD computation. A sample page from the Internet site may include and provide the following:

Recommendation on Evaluation and Management

Option A: See a Chiropractor to obtain Prescription for MRI Script first

Office Evaluation by:

Dr. Jones (Chiropractor) Visit Initial (Free Spine advice) cost=$75

(Includes Free X-Rays if Necessary)

Dr. Andrews (Chiropractor) Visit Initial (Free Spine advice) cost=$75

(X-rays not included)

IMAGING (MRI) COSTS by:

WEST COAST RADIOLOGY: (LUMBAR MRI WITHOUT CONTRAST)=(Free Spine advice) $525

RADIOLOGY PASCO COUNTY:(LUMBAR MRI WITHOUT CONTRAST)=(Free Spine advice) $725

TOTAL COST=$600: Dr. Jones+West Coast Radiology to get MRI: (BEST VALUE AND RATINGS)

TOTAL COST=$800: Dr. Jones+RADIOLOGY PASCO COUNTY to get MRI:

TOTAL COST=$600: Dr. Andrews+West Coast Radiology to get MRI: (BEST VALUE)

TOTAL COST=$800: Dr. Andrews+RADIOLOGY PASCO COUNTY to get MRI:

2 of choices above have equal Value savings but one choice has superior patient ratings

Option B: See a Board Certified Spinal Surgeon to obtain MRI Script first:

Dr. Hayes (Orthopedic Surgeon) Initial Visit Free Spine advice cost=$800

Dr. French (Neurosurgeon) Initial Visit Free Spine advice cost=$1000

Dr. George Neurosurgeon) Initial Visit Free Spine advice cost=$1050

(Includes all x-rays and free sample medication (“Click Here” for more details)

IMAGING (MRI) COSTS by:

WEST COAST RADIOLOGY: (LUMBAR MRI WITHOUT CONTRAST)=(Free Spine advice) $525

RADIOLOGY PASCO COUNTY:(LUMBAR MRI WITHOUT CONTRAST)=(Free Spine advice) $725

TOTAL COST=$1325: Dr. Hayes+West Coast Radiology to get MRI: (BEST VALUE AND RATINGS)

TOTAL COST=$1525: Dr. Hayes+RADIOLOGY PASCO COUNTY to get MRI

TOTAL COST=$1525: Dr. French+West Coast Radiology to get MRI

TOTAL COST=$1725: Dr. French+RADIOLOGY PASCO COUNTY to get MRI

TOTAL COST=$1575: Dr. George+West Coast Radiology to get MRI

TOTAL COST=$1775: Dr. George+RADIOLOGY PASCO COUNTY to get MRI

Referring to FIGS. 6A and 6B, there is shown a patient (user) profile example generated by and stored in a database of the present system/website/programming. The profile consists of 1) questions answered by the user and the order in which they were answered, 2) virtual body data, (including location and characteristics of symptoms), and 3) virtual physical exam results. A patient/user logs onto the present website and begins to answer the pre-determined questions/questioning (an example of which is shown in FIGS. 6A and 6B. From the answers to the pre-determined questions, the system provides a summary of the patient profile. From the patient profile summary, a differential diagnosis and baseline likelihood of diagnosis (Dx) is provided.

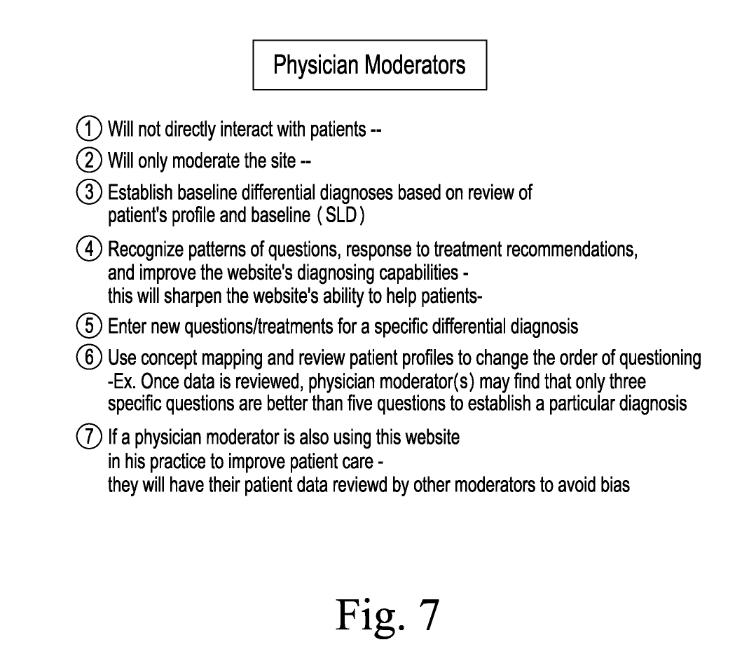

FIG. 7 sets forth the various aspects and/or responsibilities of the physician moderator of the present system. The physician moderator has many roles with respect to the present system as presented in FIG. 7.

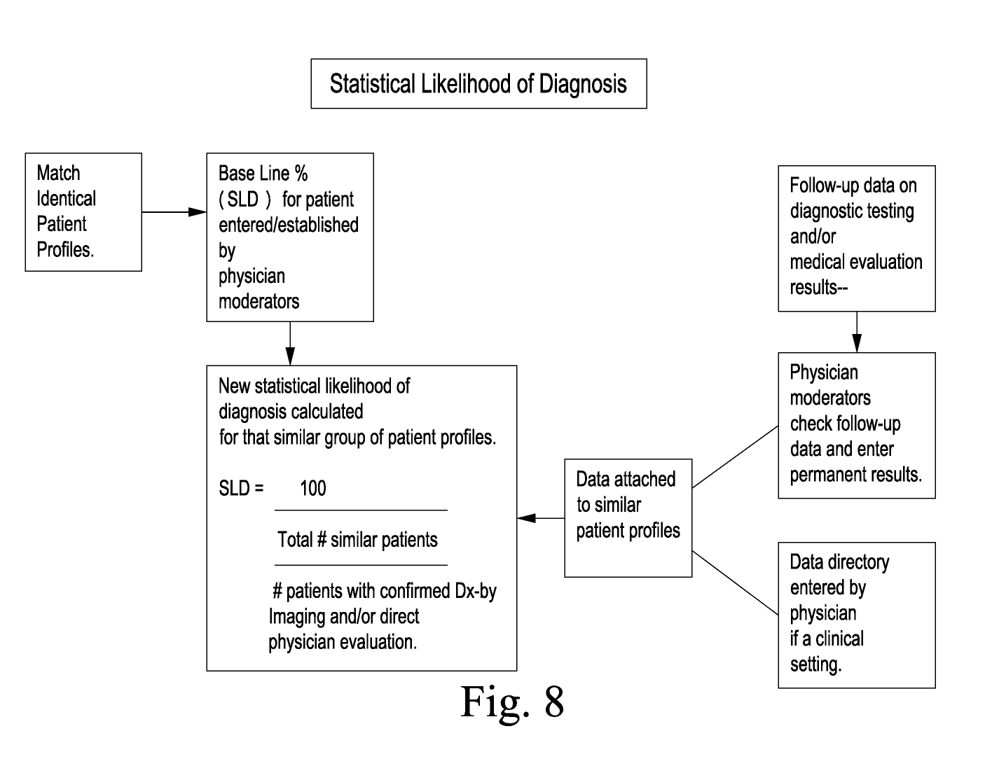

FIG. 8 shows an algorithm used for determining the statistical likelihood of diagnosis (SLD). The algorithm matches identical patient profiles and uses their data (including their differential diagnosis) for establishing a baseline % SLD by the physician moderators to provide a new SLD with the input of the confirmatory data, physician moderator follow-up and data entered by medical facilities. Details of the algorithm are provided in and are evident from the figure.

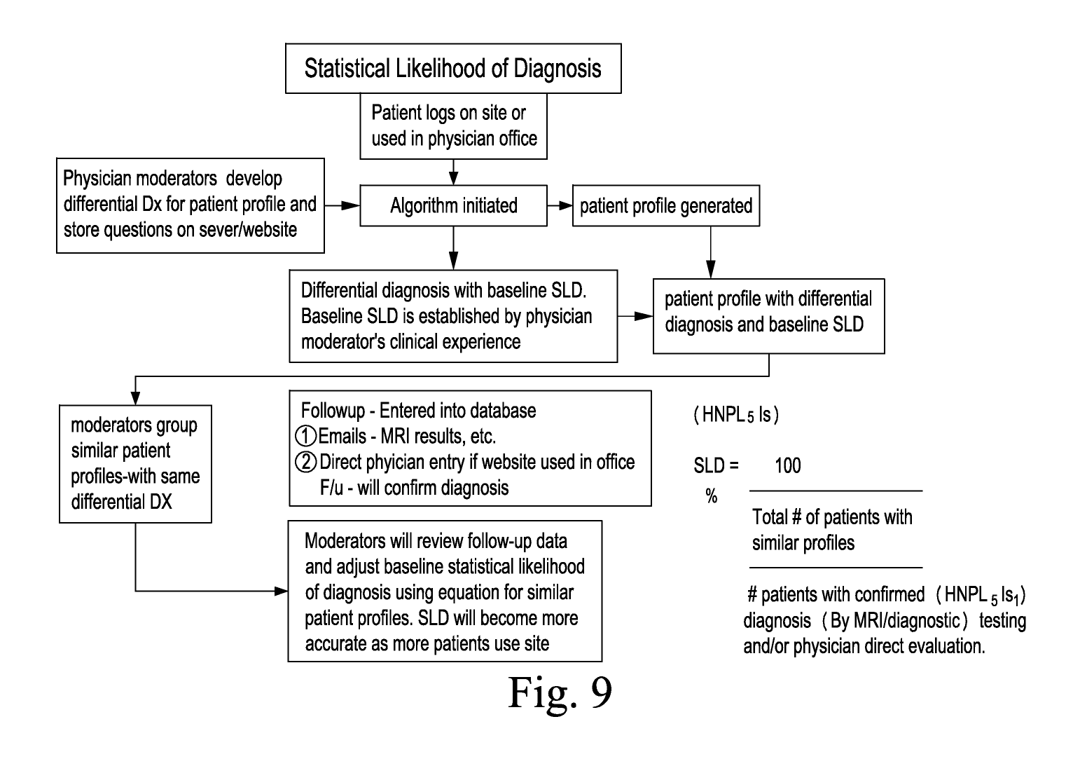

FIG. 9 shows more of the algorithm used for determining the statistical likelihood of diagnosis (SLD) by the present system, as well as the role of the physician moderator(s) within the system. The algorithm begins with the use logging into the website, wherein the system algorithm is initiated. Details of the algorithm are provided in and are evident from the figure.

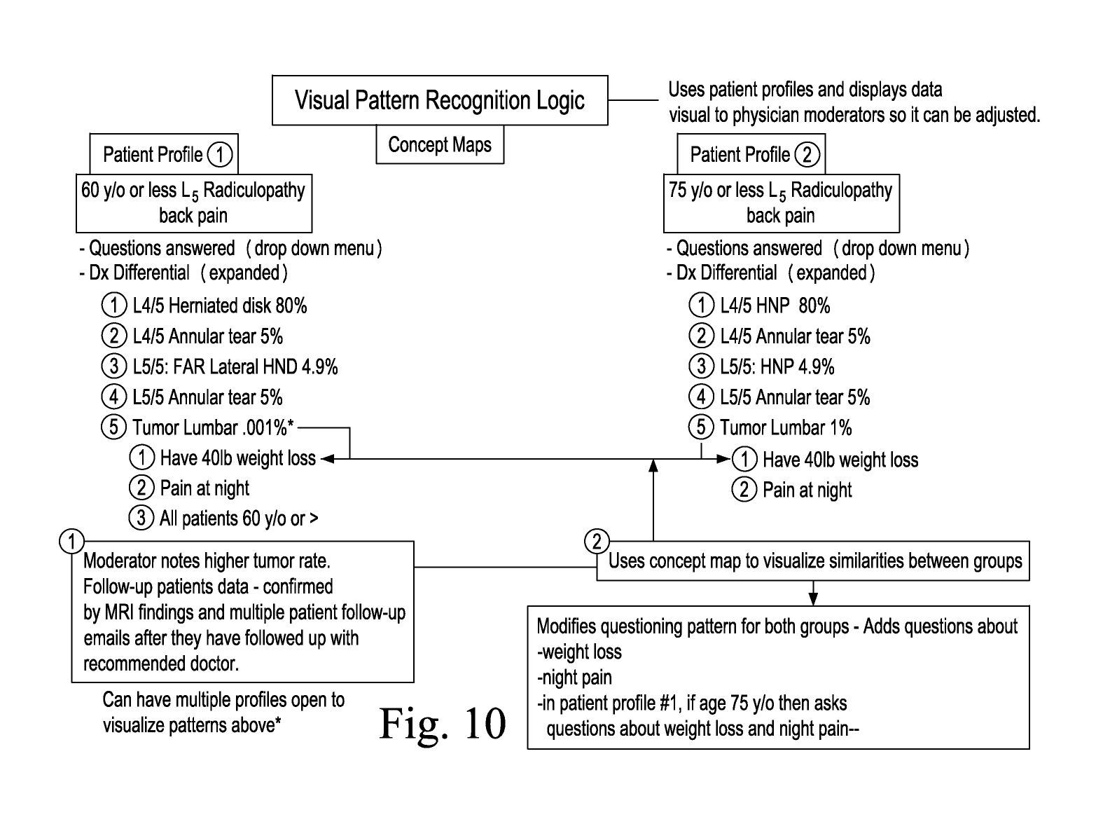

FIG. 10 shows the visual pattern recognition logic used by the present system to group similar patient profiles together to allow for pattern recognition by the physician moderators. Particularly, the physician moderator uses this information and system data to improve the SLD by moderating the questions/questioning for providing the differential diagnosis and SLD. Details of the algorithm are provided in and are evident from the figure.

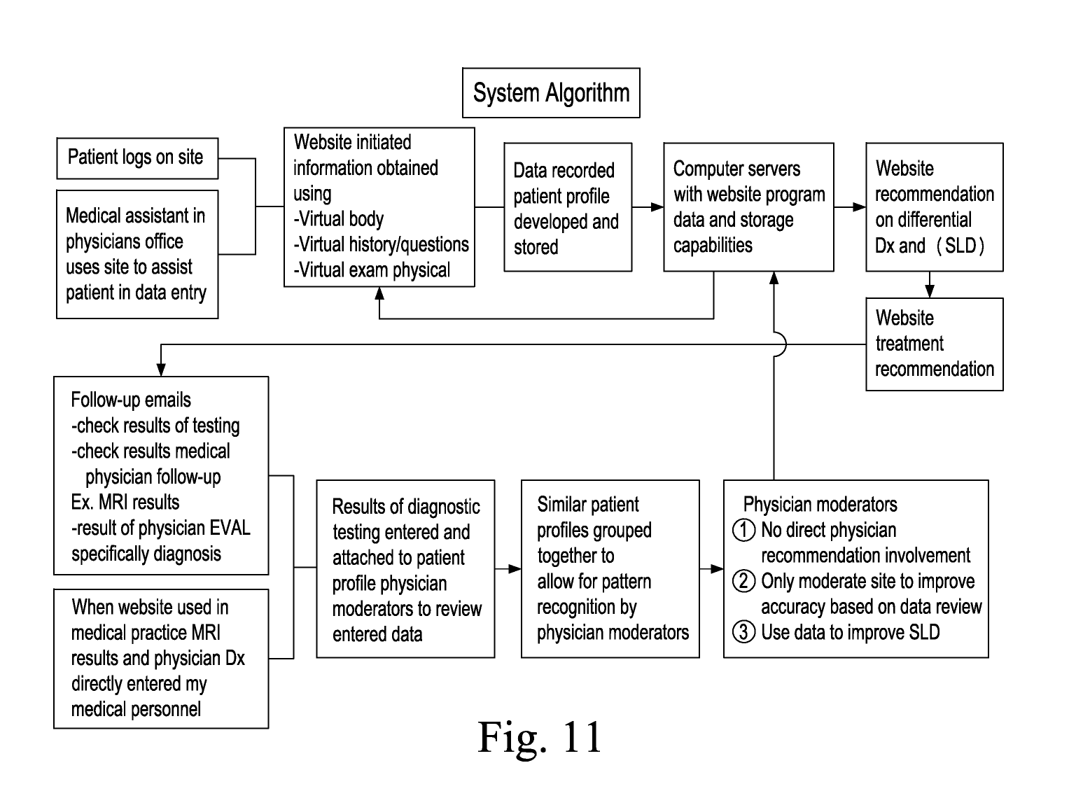

FIG. 11 shows an overall system algorithm for providing a user with a differential diagnosis and its statistical likelihood of diagnosis based on user input into the website, pre-determined physician moderator generated questions/questioning posed by the website and answered by the user, and pattern recognition programming that utilizes confirmatory data and physician moderator oversight. Details of the algorithm are provided in and are evident from the figure.

The present system uses physician moderators that are trained board certified US experts in their respective medical field. The physician moderators are responsible for developing the order and content of the pre-determined questions/questioning, treatment recommendations, baseline differential diagnosis percentages (%) based on physician experience. Incoming data obtained by the system and confirmatory data is used to improve the questions/questioning and treatment recommendations and SLD of the website. A moderating team of a group of physicians from different demographic regions throughout the US may be used as a substitute for or in addition to a physician moderator in order to broaden the initial medical evaluation and treatment recommendations, and to avoid physician bias as there will be multiple physicians involved. The physician moderator(s) will sort through diagnostic testing results of patients (confirmatory data) to revise the pre-determined questions/questioning and diagnoses to avoid misdiagnosis or entry of inaccurate (or mistakes) in report data. Non-trustworthy data will be omitted. Objective test results are used as confirmation of the correct diagnosis. The aforementioned programming provides superior means of strengthening the diagnostic ability of the website.

The present system/program/website uses all three (3) components of the accepted medical diagnosis process that an actual live physician would normally use to evaluate and treat a patient—a physical exam (in the present system, a virtual physical exam), patient history (in the present system, virtual history taking that is pre-programmed—i.e. through predetermined questions/questioning, but moderated), and providing results of diagnostic testing (in the present system, confirmatory data).

The present system generates and sends emails and/or other manners of communication to follow up with the user/patient in order to ascertain whether the system made the correct diagnosis from the differential diagnoses. Preferably, but not necessarily, physicians/physician offices and/or other medical facilities, labs, testing facilities and/or the like (collectively, medical facilities) connect to the website to provide confirmatory data (e.g. confirmed diagnoses) for users of the website that are patients of the medical facility. In view of the confirmatory data and other information generated by the system, lines of questioning can be added, order of questioning or actual questioning may be changed. For example, the system moderators notice that it is more efficient to ask five (5) specific questions to diagnosis a herniated disk. The moderators note that 100% of patients with herniated disks at L5-S1 answer these questions the same. The moderators alter the questions typically asked to confirm a L5-S1 herniated disk—the five (5) questions are asked first to accomplish the same diagnosis in a shorter and more efficient manner.

It should be noted that tools like those described above can be used for medical education while the website can be used to guide medical professionals and medical students through the interview process, as well as teaching them what questions are more important if a specific diagnosis is suspected.

Also, the present system allows medical professionals in the office to use the present website to assist/guide them during a physician evaluation. A medical assistant can use the website to obtain the data from the patient and shorten the time needed by the physician to obtain the information. The physician can then directly enter the confirmed diagnosis (confirmatory data) into the system and the means of determining the diagnosis, IE, MRI or other diagnostic testing. If a physician is using the website/program/system via the office they will be granted additional website privileges so they can confirm the diagnosis. If the physician is just a user of the system for input of confirmatory data, they will not, however, be able to moderate the program. The website moderators will ultimately review this data to confirm that the diagnosis is sound. This avoids bias. Additionally, the moderators will use this data to improve lines of questioning, treatment recommendations, and improve the baseline SLD statistical likelihood of a diagnosis.

While the invention has been illustrated and described in detail in the drawings and the foregoing description, the same is to be considered as illustrative and not restrictive in character and that all changes and modifications that come within the spirit of the invention are desired to be protected.

All references cited in this specification are incorporated herein by reference to the extent that they supplement, explain, provide a background for or teach methodology or techniques employed herein.

What is claimed is:

1. A method for providing medical advice via the Internet as shown and described herein.

2. A system for providing medical advice via the Internet as shown and described herein.

3. A system for providing a medical diagnosis to a patient via the Internet as shown and described herein.
